(19) United States
(12) Patent Application Publication
(10) Pub. No.: US 2003/0204589 A1
(43) Pub. Date: Oct. 30, 2003

(54) Data transmitting/receiving system, transmitting device, and data transmitting/receiving method

(75) Inventor: Yasushi Ishizuka, Hamura-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/365,514

(22) Filed: Feb. 13, 2003

(30) Foreign Application Priority Data
Apr. 26, 2002 (JP) 2002-126458

(51) Int. Cl. G06F 15/173

(52) U.S. Cl. 709/224

(57) ABSTRACT

A transmitting device is provided with a TV tuner for receiving television broadcasts, a DVD player for reading out data from a DVD medium, etc. Based on the wireless communications between the transmitting device and the user's small terminal carried by the user, the ID of a receiving device that is located in the neighborhood of the user is acquired. The transmitting device 1 transfers a variety kinds of data, including television broadcast data received by the TV tuner and the DVD data read out by the DVD player, to the recognized receiving device identified by the ID received from the user's small terminal.

### CROSS-REFERENCE TO RELATED APPLICATIONS

This application is based upon and claims the benefit of priority from the prior Japanese Patent Application No. 2002-126458, filed Apr. 26, 2002, the entire contents of which are incorporated herein by reference.

### BACKGROUND OF THE INVENTION

1. Field of the Invention

The present invention relates to a data transmitting/receiving system, a transmitting device and a data transmitting/receiving method, which cause a tuner-provided transmitting device to receive a television broadcast and transfer data on the received television broadcast to a remote receiving device provided with a monitor and a loudspeaker. More specifically, the present invention relates to a technique of automatically switching receiving devices to which data is transferred from a transmitting device.

2. Description of the Related Art

In recent years, a technique for setting up a network using wireless communications, such as Bluetooth and IEEE802.11, has received much attention. For example, a data transmitting/receiving system comprising a non-portable electronic device serving as a transmitting device and a portable electronic device serving as a receiving device, is being developed. The non-portable electronic device is provided with a television broadcast-receiving tuner and a DVD player, and the audio/video data received or read out by the transmitting device is reproduced by the monitor and loudspeaker of the receiving device.

The data transmitting/receiving system is advantageous in that the receiving device can be placed anywhere desired, without reference to the location of the transmitting device. Even if the transmitting device must be installed in the neighborhood of an antenna connection terminal, the user can move the receiving device to any desirable place and enjoy the television broadcast there, with no need for cable connection or other troublesome operations.

In this type of data transmitting/receiving system, the transmitting device and the receiving device are correlated to have a fixed one-to-one relationship. When the user moves from one room to another, he or she has to carry the receiving device even if a wireless electronic device comprising a monitor and a loudspeaker is present in the room the user is moving to. Alternatively, the transmitting device has to be correlated with the receiving device installed in the room the user is going to. Otherwise, the user cannot continue to enjoy the television broadcast.

Currently, there are few devices capable of exchanging data by wireless. Under the circumstances, the one-to-one connection configuration of devices, namely, correlating transmitting and receiving devices as a pair, is not a problem. However, since wireless devices are expected to increase in number, it is highly probable that the one-to-one connection configuration will be unpractical, and one transmitting device will be used in correspondence to a number of receiving devices. Then, the user will feel that he or she would like to receive the broadcast data, using the receiving device installed in the room he or she is going to, rather than carrying the receiving device with he or her. Let us consider a case where the user is enjoying DVD video on a large-screen display and the DVD video is received by the transmitting device installed in a room different from the room in which the large-screen display is installed. If, under this situation, the dinner time comes, the user may move to the kitchen and start preparing dinner, while watching the DVD video on a small-screen display installed in the kitchen. In this manner, if the user moves from one room to another without carrying the receiving device, the transmitting device has to be flexibly switched from that receiving device to another. The prior art configuration, however, does not enable such flexible switching.

### BRIEF SUMMARY OF THE INVENTION

An embodiment of the present invention may provide a data transmitting/receiving system, a transmitting device, and a data transmitting/receiving method, which enable a transmitting device to be automatically switched to a receiving device to which data should be transferred, in accordance with the place the user is going to.

According to an aspect of the invention, it provides a data transmitting/receiving system comprising: a transmitting device configured to transmit data; and a plurality of receiving devices configured to receive data from the transmitting device, the transmitting device including: a recognizing unit configured to recognize which one of the receiving devices is located in a neighboring region of a predetermined user; and a data transmission-controlling unit configured to transmit data to the receiving device recognized by the recognizing unit.

The another aspect of the invention also provides a transmitting device configured to transmit data to one of a plurality of receiving devices, the transmitting device comprising: a recognizing unit configured to recognize which one of the receiving devices is located in a neighboring region of a predetermined user; and a data transmission-controlling unit configure to transmit data to the receiving device recognized by the recognizing unit.

The another aspect of the invention further provides a data transmitting/receiving method for transmitting data from a transmission device to one of a plurality of receiving devices, the method comprising: recognizing which one of the receiving devices is located in a neighboring region of a predetermined user; and transmitting data to a receiving device that has been recognized.

The another aspect of the invention is applied to a case where receiving devices are installed in respective rooms. When a user wants to enjoy a television broadcast by use of the receiving device of a room, the transmitting device is made to recognize which one of the receiving devices is located in the neighborhood of the user, and transfers the data on the television broadcast to the recognized receiving device.

Additional features and advantages of the invention will be set forth in the description which follows, and in part will be obvious from the description, or may be learned by practice of the invention. The features and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram illustrating a data transmitting/receiving system according to an embodiment of the present invention.

FIG. 2 is a diagram illustrating a transmitting device employed in the data transmitting/receiving system of the embodiment.

FIG. 3 is a diagram illustrating a receiving device and a user's small terminal, which are employed in the data transmitting/receiving system of the embodiment.

FIG. 4 is a correspondence table stored in the transmitting device of the embodiment and representing the correspondence between user's small terminals and receiving devices that are connectable to the transmitting device.

FIG. 5 shows examples of configuration data stored in the transmitting device and representing configurations of the receiving devices.

FIG. 6 is a correspondence table stored in a receiving device of the embodiment and representing the correspondence between user's small terminals and transmitting device that are connectable to the receiving device.

FIG. 7 is a correspondence table stored in a user's small terminal of the embodiment and representing the correspondence between a transmitting device and a receiving device that are connectable to the user's small terminal.

FIG. 8 is a flowchart illustrating how a user's small terminal operates in the data transmitting/receiving system of the embodiment.

FIG. 9 is a flowchart illustrating how the transmitting device operates in the data transmitting/receiving system of the embodiment.

### DETAILED DESCRIPTION OF THE INVENTION

One embodiment of the present invention will now be described with reference to the accompanying drawings.

FIG. 1 is a diagram illustrating a data transmitting/receiving system according to the embodiment of the present invention.

As shown in FIG. 1, the data transmitting/receiving system comprises: a transmitting device 1, a plurality of receiving devices, and a user's small terminal 3. Data is exchanged by wireless between the transmitting device 1 and each receiving device 2, between the transmitting device and the user's small terminal 3, and between each receiving device 2 and the user's small terminal 3.

The transmitting device 1 is an electronic device for which major functions of the data transmitting/receiving system are provided. For example, the transmitting device 1 is provided with a TV tuner 11 for receiving television broadcasts and a DVD player 12 for reading out data from a DVD medium. The TV broadcast data received by the TV tuner 11 and the data read out by the DVD player 12 are transferred from the transmitting device to one of the receiving devices 2. Images are displayed on a display 21 of the receiving device 2, and sound is reproduced from a loudspeaker 22. The data transmitting/receiving system recognizes a receiving device 2 that is located in the neighborhood of the user, and transfers data of various kinds to that recognized receiving device 2.

An interphone 13a, a security camera 13b, a fire alarm 13c and other devices are connected to the transmitting device 1. When someone visits the house or something unusual happens inside or outside the house, some phenomenon or other is detected to inform the user of the visit or happening. The transmitting device 1 sends data to the receiving device 2 located in the neighborhood of the user, thereby notifying the user of the visit or happening.

The receiving station 2 is an electronic device that plays a passive role in the data transmitting/receiving device. It receives data transferred from the transmitting device 1 and outputs it through the display 21 or the loudspeaker 22. One receiving device is installed in each room, so that the system as a whole is provided with a plurality of receiving devices

The user's small terminal 3 is an electronic device that serves as an interface between the transmitting device and each receiving device. By way of example, the user's small terminal 3 is shaped like a wristwatch and carried on the wrist of the user.

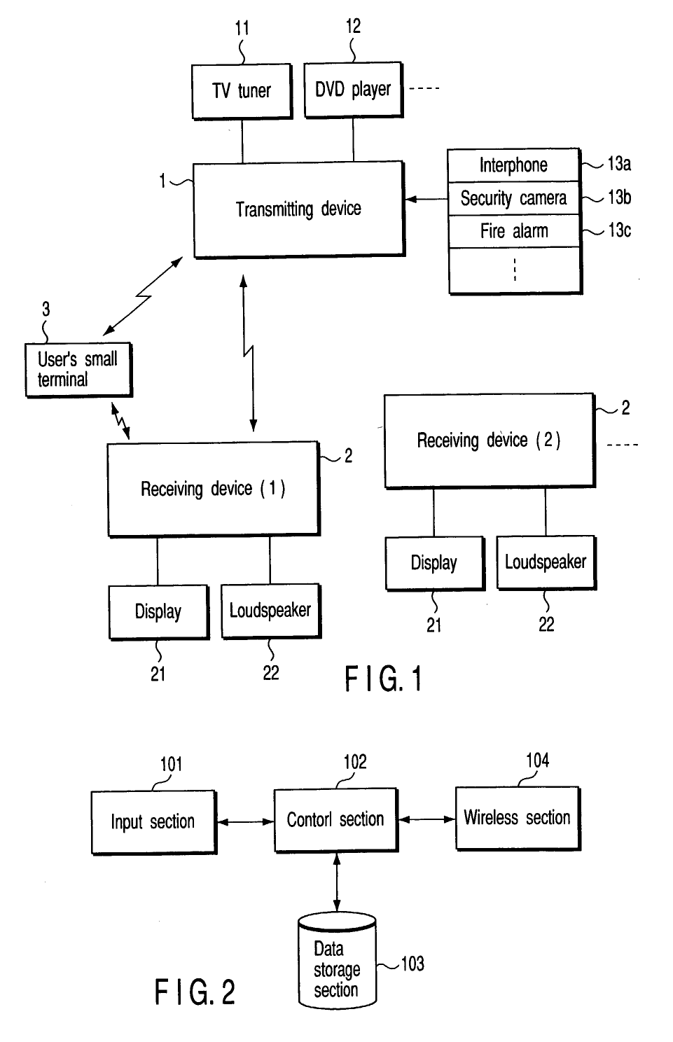

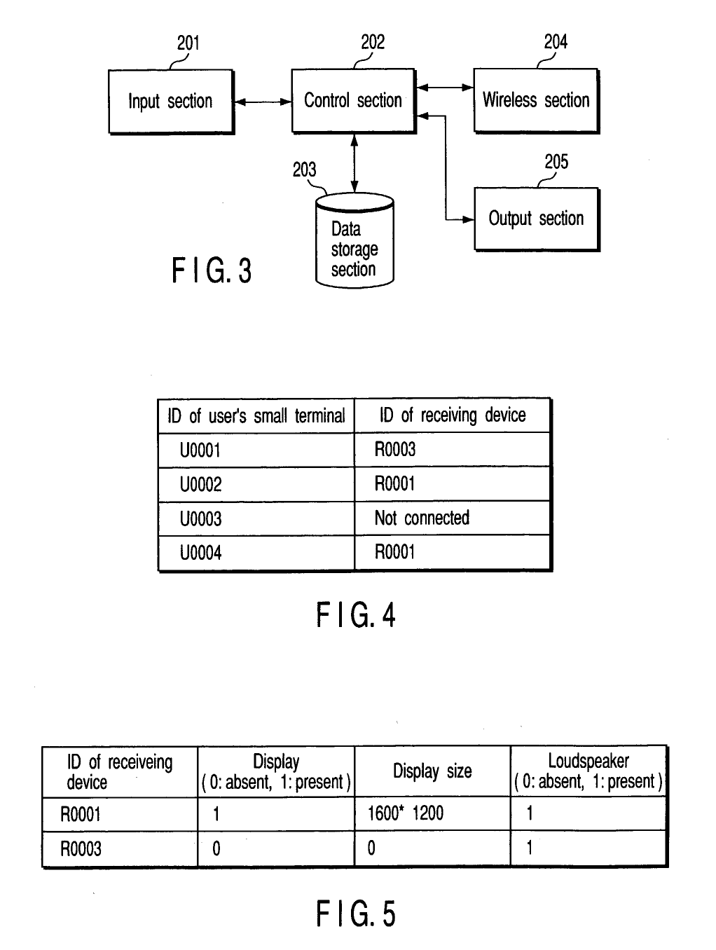

FIG. 2 is a diagram illustrating the transmitting device employed in the data transmitting/receiving system. FIG. 3 is a diagram illustrating one receiving device and the user's small terminal both employed in the data transmitting/receiving system.

As shown in FIG. 2, the transmitting device 1 comprises an input section 101, a control section 102, a data storage section 103 and a wireless section 104. The input section includes a keyboard, a mouse, a remote control, an input device (e.g., a touch pad), etc. Information of various kinds are entered from the input section, and devices are operated using the input section. The control section 102 controls the entirety of the transmitting device 1. For example, it controls the data transmission and reception using a wireless function.

The data storage section 103 is a memory device that stores data of various kinds. For example, it stores the ID of the connected receiving device 2, the ID of the user's small terminal, and the configuration information on each receiving device. The wireless section 104 exchanges data using wireless technology, such as Bluetooth, IEEE802.11, infrared data communication.

As shown in FIG. 3, the receiving device 2 and the user's small terminal 3 each comprises: an input section 201, a control section 202, a data storage section 203, a wireless section 204 and an output section 205. The input section 201, control section 202, data storage section 203 and wireless section 204 correspond to the same-name elements 101-104 of the transmitting device 1 shown in FIG. 2. That is, each of the receiving device 2 and the user's small terminal 3 is similar to the transmitting device 1, except for the addition of the output section 205. The data storage section 203 of the receiving device 2 stores the ID of the transmitting device 1, the ID of the user's small terminal 3, etc. Likewise, the data storage section 203 of the user's small terminal 3 stores the ID of the transmitting device 1, the ID of the receiving device, etc. The output section 205 reproduces received data, using devices such as the display 21 and the loudspeaker 22.

The data stored in the transmitting device 1, receiving device 2 and user's small terminal will be described with reference to FIGS. 4, 5, 6 and 7.

FIGS. 4 and 5 illustrate examples of data stored in the transmitting device 1. FIG. 4 is a correspondence table representing the correspondence between user's small terminals and receiving devices that are connectable to the transmitting device 1. FIG. 5 shows examples of configuration data representing configurations of the receiving devices.

The correspondence table shown in FIG. 4 illustrates the case where user's small terminal U0001 is connected to receiving device R0003, user's small terminals U0002 and U0004 are connected to receiving device R0001, and user's small terminal U0003 is not connected to any one of the receiving devices. The configuration data in FIG. 5 shows that receiving device R0001 is provided with both a display and a loudspeaker and the display size is 1600*1200 dots. The configuration data also shows that receiving device R0003 is provided only with a loudspeaker.

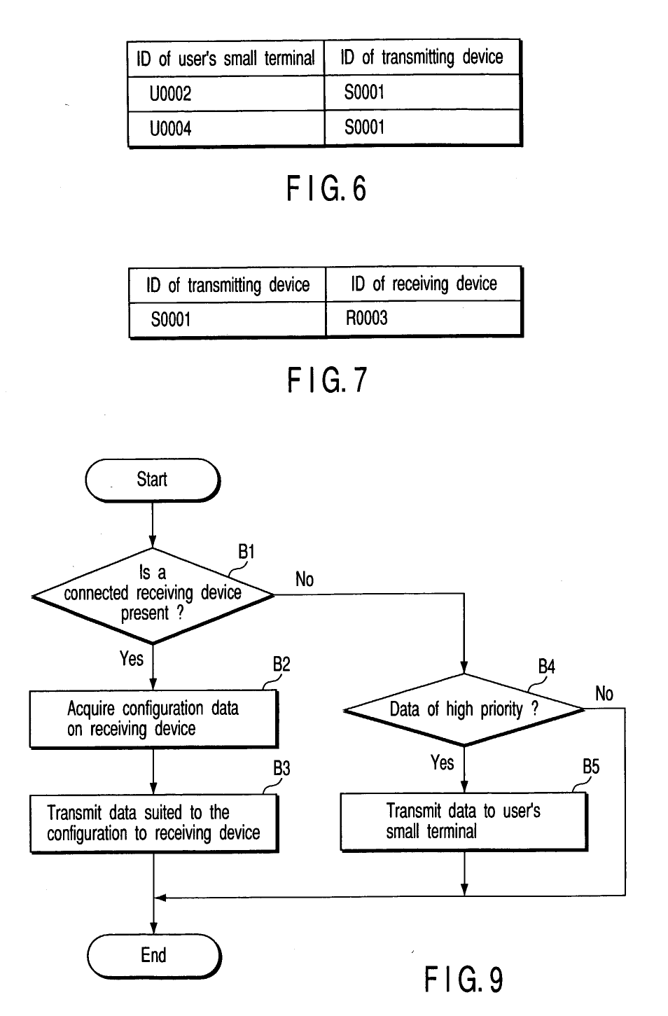

FIG. 6 is a correspondence table stored in a receiving device and representing the correspondence between user's small terminals and transmitting device that are connectable to that receiving device. The correspondence table shown in FIG. 6 is data pertaining to receiving device R0001 and illustrates the case where both user's small terminals U0002 and U0004 are connected to that receiving device R0001.

FIG. 7 is a correspondence table stored in the user's small terminal 3 and representing the correspondence between the transmitting device 1 and receiving device 2 that are connectable to the user's small terminal 3. The correspondence table in FIG. 7 is data pertaining to user's small terminal U0001 and illustrates the case where transmitting device S0001 and receiving device R0003 are connected to user's small terminal U0001.

The operating principles of the data transmitting/receiving system will be described.

First of all, the user's small terminal 3 owned by the user makes preparations of wireless data transmission and reception. That is, it establishes the wireless connection to the transmitting device 1. As a result of this processing, the transmitting device 1 ascertains who is in the house. After this connection processing, the ID of the user's small terminal 3, such as that shown in FIG. 4, is stored in the transmitting device 1. Let us assume that the user thereafter moves from the room in which the transmitting device 1 is installed and enters another room, so as to check the data (e.g., DVD data) in the AV device connected to the transmitting device 1. When the user comes close to the receiving device 2 in the room the user has entered, the device IDs are automatically exchanged between that receiving device 2 and the user's small terminal 3. As a method for automatically exchanging the IDs, it is possible to use wireless communications that are based on radio waves. However, this method for communications provides long-distance communications and is not much intercepted by an object located between communication points. Since it is likely that ID exchange will be executed between all persons in the house, the communications method based on radio waves are not necessarily suitable for use in a house of ordinary size. To avoid unnecessary communications, it is thought to use wireless technology based on infrared rays since this technology provides a narrow connection range and has directional property. That is, the technology based on infrared rays enables ID exchange between the users located in the neighborhood of the receiving devices.

After the end of the ID exchange, the user's small terminal 3 sends the ID of the receiving device 2 located in the neighborhood of the user to the transmitting device 1. Upon receipt of the ID of the receiving device 2, the transmitting device 1 executes connection processing with reference to the receiving device corresponding to the ID. After the connection processing between the transmitting device 1 and the receiving device 2 ends, the transmitting device 1 transmits its data to the receiving device 2. Before this transmission, the transmitting device 1 prepares data suited to the configurations of the receiving device 2 which are acquired beforehand. The configurations include the presence/absence of a display, the size of the display (if present), the presence/absence of a loudspeaker, etc. (If the receiving device 2 is not provided with a display, only audio data is transmitted.)

Since the processing described above is executed, the user does not have to carry a receiving device when he or she moves from one place to another in the house. The user can receive the data transmitted from the transmitting device 1 through the receiving device 2 located in the place the user goes to. In this manner, the user can use a suitable communications function.

The data transmitting/receiving system may be provided with additional functions as follows:

(1) Where the interphone 13a, security camera 13b, fire alarm 13c or another type of device is connected to the transmitting device 1, and if something undesirable happens, the transmitting station 1 is notified of this, and the information is transmitted to the receiving device 2 located in the neighborhood of the user. The user can therefore take immediate action to cope with the happening whether it occurred inside or outside the house. Since a high priority should be given to this kind of information, the transmitting device 1 may transmit that information to the user's small terminal 3 so that the user can take immediate action even when he or she is not located in the neighborhood of the receiving device 2 (i.e., even when the transmitting device 1 is not connected to the receiving device 2 located in the neighborhood of the user).

(2) Notification data from the security camera 13b or fire alarm 13c must be provided with the highest priority. This kind of data is therefore transmitted to all receiving devices 2 that are connected to the transmitting device 1. Since all users can receive the notification data at a time, they can take immediate action in response to the notification data.

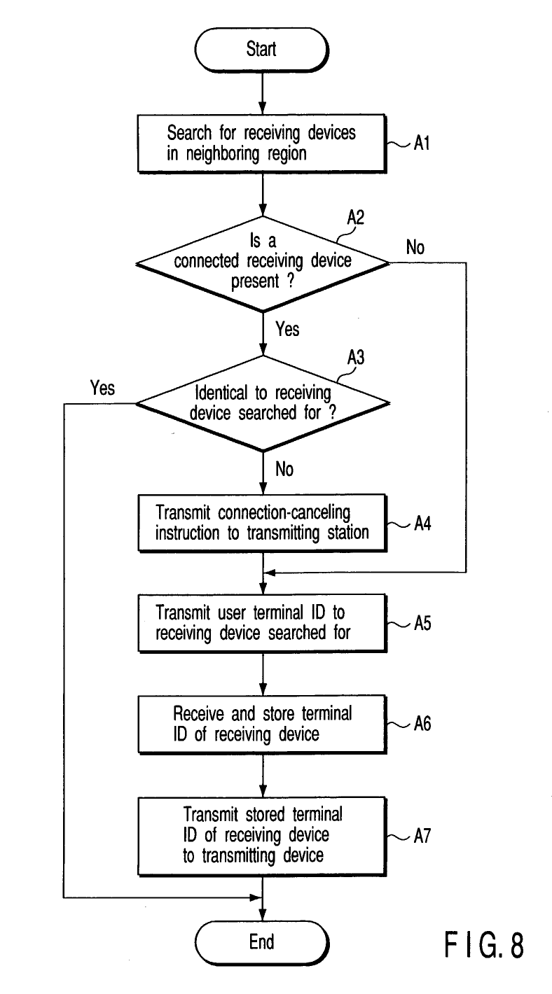

An operation of the data transmitting/receiving system will now be described with reference to the flowcharts shown in FIGS. 8 and 9.

FIG. 8 is a flowchart illustrating how a user's small terminal operates in the data transmitting/receiving system.

First of all, the user's small terminal 3 carried by the user searches for receiving devices 2 in the neighboring region (Step A1) and checks whether there is a receiving device 2 that is connected to the transmitting device 1 (Step A2). If a connected receiving device 2 is present (“YES” in Step A2), then the user's small terminal 3 examines if it is the same device 2 as has been searched for (Step A3). If it is not (“NO” in step A3), the receiving device 2 is disconnected by sending a connection-canceling instruction to the transmitting device 1 (Step A4).

The user's small terminal 3 transmits the ID assigned thereto to the receiving station 2 (Step AS), receives the ID of the receiving station 2, and stores the received ID (Step A6). Then, the user's small terminal transmits the ID of a newly-connected receiving station to the transmitting device 1 (Step A7).

FIG. 9 is a flowchart illustrating how the transmitting device operates in the data transmitting/receiving system.

First of all, the transmitting device 1 examines if there is a receiving device 2 connected thereto (Step B1). If such a receiving device 2 is present (“YES” in Step B1), it acquires the configuration data on that receiving device 2 (Step B2) and transmits data best suited to the acquired configuration data to the receiving device 2 (Step B3).

On the other hand, if the receiving device 2 is not present (“NO” in step B1), the transmitting device 1 examines whether the data it is going to transmit is of high priority (Step B4). If the data is of high priority (“YES” in step B4), then the transmitting device 1 starts transmitting the data to the user's small terminal 3 carried by the user (Step B5).

As described above, the data transmitting/receiving device can recognize a receiving device 2 located in the neighborhood of the user, and transmits data to that receiving device 2. Therefore, the user can receive data from the nearest receiving device 2 without reference to his or her location in the house.

Even if no receiving device 2 is connected to the transmitting device 1, data of high priority is sent to the user's small terminal 3 carried by the user. The user can therefore receive the data of high priority without delay.

In the above description, reference was made to the case where the user's small terminal 3 detects a new receiving device 2 that is different from the receiving device 2 kept connected until then, and sends the ID of the newly-detected receiving device 2 to the transmitting device 1. Instead of this, the user's small terminal 3 may detect that the disconnection from a given receiving device 2 continues for more than a predetermined length of time. Upon detection of this state, the user's small terminal 3 determines that it has been moved to a position far from the given receiving device 2 and sends the information to the transmitting device 1. If this alternative configuration is adopted, it is possible to immediately reflect the movement of the user when data transfer is performed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data transmitting/receiving system comprising:
a transmitting device configured to transmit data; and
a plurality of receiving devices configured to receive data from the transmitting device,
the transmitting device including:
a recognizing unit configured to recognize which one of the receiving devices is located in a neighboring region of a predetermined user; and
a data transmission-controlling unit configured to transmit data to the receiving device recognized by the recognizing unit.

2. The data transmitting/receiving system according to claim 1, wherein the transmitting device and the receiving device exchange data by wireless communications.

3. The data transmitting/receiving system according to claim 1, wherein the transmitting device further includes a managing unit configured to manage a data reproduction function provided for each of the receiving devices,
the data transmission-controlling unit prepares transmission data in accordance with the data reproduction function of each receiving device managed by the managing unit.

4. The data transmitting/receiving system according to claim 1, further comprising:
a small terminal device including a detection unit configured to detect which one of the receiving devices is located within a predetermined region, and a notification unit configure to notify the transmitting device of identification data on the receiving device detected by the detection unit,
the recognizing unit of the transmitting device recognizes which one of the receiving devices can receive data, on the basis of the identification data sent from the notification unit of the small terminal device.

5. The data transmitting/receiving device according to claim 4, wherein the detection unit of the small terminal device detects a receiving device based on wireless communications, and acquires identification data from the detected receiving device.

6. The data transmitting/receiving device according to claim 4, wherein, when the detection unit of the small terminal device newly detects another receiving device different from any one of the receiving devices, the notification unit of the small terminal device notifies the transmitting device of identification data on the another receiving device.

7. The data transmitting/receiving device according to claim 4, wherein the detection unit of the small terminal device detects that the receiving device detected last time moves out of the predetermined region,
the notification unit of the small terminal device notifies the transmitting device of a time when the detection unit of the small terminal device detects that the receiving device detected last time moves out of the predetermined region.

8. The data transmitting/receiving device according to claim 4, wherein the data transmission-controlling unit of the transmitting device operates such that when data must be transmitted to a given user and if the recognizing unit of the transmitting device recognizes none of the receiving devices, the data transmission-controlling unit transmits data to the small terminal device, thereby notifying the user that data to be transmitted is present.

9. The data transmitting/receiving device according to claim 8, wherein the transmitting device further includes a determination unit configured to determine priority of each data,
the data transmission-controlling unit of the transmitting device starts transmits data to the small terminal device only when the determination unit determines that the priority of the data is higher than a preset level.

10. A transmitting device configured to transmit data to one of a plurality of receiving devices, said transmitting device comprising:
a recognizing unit configured to recognize which one of the receiving devices is located in a neighboring region of a predetermined user; and
a data transmission-controlling unit configure to transmit data to the receiving device recognized by the recognizing unit.

11. The transmitting device according to claim 10, further comprising:
a wireless communication unit configured to exchange data with the receiving devices by wireless communications.

12. The transmitting device according to claim 10, further comprising:
a managing unit configured to manage a data reproduction function provided for each of the receiving devices,
the data transmission-controlling unit configured to prepare transmission data in accordance with the data reproduction function of each receiving device managed by the managing unit.

13. A data transmitting/receiving method for transmitting data from a transmission device to one of a plurality of receiving devices, the method comprising:
recognizing which one of the receiving devices is located in a neighboring region of a predetermined user; and
transmitting data to a receiving device that has been recognized.

14. The data transmitting/receiving method according to claim 13, wherein the transmitting step prepares the data transmitted to each receiving device in accordance with a data reproduction function of each receiving device.

15. The data transmitting/receiving method according to claim 13, wherein the recognizing step recognizing one of the receiving devices that is capable of receiving data, based on identification data sent by a small terminal device, the small terminal device including a detection unit configured to detect which one of the receiving devices is located within a predetermined region, and a notification unit configured to notify the transmitting device of identification data on the receiving device detected by the detection unit.

16. The data transmitting/receiving method according to claim 15, wherein the transmitting step transmits to the small terminal device data which notifies a given user that there is data to be transmitted, when the data must be transmitted to the given user and if none of the receiving devices is recognized.

17. The data transmitting/receiving method according to claim 16, further comprising:
determining priority of each data,
the transmitting step transmits data to the small terminal device only when the priority of the data is determined to be higher than a preset level.
